(19) United States
(12) Patent Application Publication
(10) Pub. No.: US 2020/0293823 A1
(43) Pub. Date: Sep. 17, 2020

(54) METHOD AND SYSTEM OF AUTO BUILD OF IMAGE ANALYTICS PROGRAM

(71) Applicant: Hitachi, Ltd., Tokyo (JP)

(72) Inventors: Daisuke ITO, Cupertino, CA (US); Nobuyuki MURANAKA, San Jose, CA (US)

(21) Appl. No.: 16/351,915

(22) Filed: Mar. 13, 2019

(51) Int. Cl. G06K 9/62

(52) U.S. Cl. CPC G06K 9/6256; G06K 9/626; G06K 9/6253; G06K 9/6268

(57) ABSTRACT

Example implementations described herein involve a question and answer based interface for the automatic construction of an object detection system. In example implementations, the interface aids in configuring an analytics server to conduct image analytics for a selected camera through the generation of a base framework with glue modules to implement the analytics.

### BACKGROUND

### Field

The present disclosure is generally directed to data analytics, and more specifically, to interfaces and systems for automatically constructing image analytics systems.

### Related Art

In the related art, there are many object detection frameworks, classifiers, locators and base networks that are provided from open source software (OSS) and academic communities. In related art implementations, an object detection framework includes a base network, a classifier and a locator, which can be technically replaceable. However, there is no versatile framework for all use cases. Accuracies of detection are affected by not only the types of target objects, but also environmental factors such as lighting conditions. Further, deciding which framework or combination of framework and base network/classifiers/locators is the best for a particular use case requires image analytics expertise. Combining frameworks also requires expertise because most of the frameworks are implemented for specific situations, making it difficult to replace the base network, classifier and locator.

Related art implementations can involve unified implementations of meta-architectures and trace out the speed/accuracy trade-off curve created by using alternative feature extractors and varying other critical parameters such as image size within each of these meta-architectures”.

### SUMMARY

Aspects of the present disclosure can involve a first server to configure a second server to conduct image analytics, the server involving a processor, configured to receive an application type, a target of an application, and a training method for the application, and a camera; determine one or more frameworks that are associated with both the application type and the target of the application; determine one or more locators and one or more classifiers associated with the application type for the one or more frameworks based on the application type; construct a base network for the one or more frameworks; extract glue modules linking the one or more classifiers and the one or more locators to the base network for the one or more frameworks; and configure the second server with the one or more frameworks to execute analytics on images received from the camera.

Aspects of the present disclosure can involve a method for a first server to configure a second server to conduct image analytics, the method involving receiving an application type, a target of an application, and a training method for the application, and a camera; determining one or more frameworks that are associated with both the application type and the target of the application; determining one or more locators and one or more classifiers associated with the application type for the one or more frameworks based on the application type; constructing a base network for the one or more frameworks; extracting glue modules linking the one or more classifiers and the one or more locators to the base network for the one or more frameworks; and configuring the second server with the one or more frameworks to execute analytics on images received from the camera.

Aspects of the present disclosure can involve a computer program with instructions for a first server to configure a second server to conduct image analytics, the instructions involving receiving an application type, a target of an application, and a training method for the application, and a camera; determining one or more frameworks that are associated with both the application type and the target of the application; determining one or more locators and one or more classifiers associated with the application type for the one or more frameworks based on the application type; constructing a base network for the one or more frameworks; extracting glue modules linking the one or more classifiers and the one or more locators to the base network for the one or more frameworks; and configuring the second server with the one or more frameworks to execute analytics on images received from the camera. The computer program can be stored in a non-transitory computer readable medium and configured to be executed by one or more processors.

Aspects of the present disclosure can involve a system involving a first server that configures a second server to conduct image analytics, the system involving means for receiving an application type, a target of an application, a training method for the application, and a camera; means for determining one or more frameworks that are associated with both the application type and the target of the application; means for determining one or more locators and one or more classifiers associated with the application type for the one or more frameworks based on the application type; means for constructing a base network for the one or more frameworks; means for extracting glue modules linking the one or more classifiers and the one or more locators to the base network for the one or more frameworks; and means for configuring the second server with the one or more frameworks to execute analytics on images received from the camera.

### BRIEF DESCRIPTION OF DRAWINGS

FIG. 1 illustrates a system diagram of an example Q&A based object detection system and auto build system in accordance with an example implementation.

FIG. 2 illustrates an example of the framework DB table in accordance with an example implementation.

FIG. 3 illustrates an example of the classifier DB table in accordance with an example implementation.

FIG. 4 illustrates an example of the locator DB table in accordance with an example implementation.

FIG. 5 illustrates an example of the base network DB table in accordance with an example implementation.

FIG. 6 illustrates an example of the glue DB table in accordance with an example implementation.

FIG. 7 illustrates an example of flow and interfaces of the Q&A system in accordance with an example implementation.

FIGS. 8-12 illustrate flow charts of example configurator processes in accordance with an example implementation.

FIG. 13 illustrates an example computing environment with an example computer device suitable for use in example implementations.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations involve a Question and Answer (Q&A) based object detection system with automatic build system and methods as described herein.

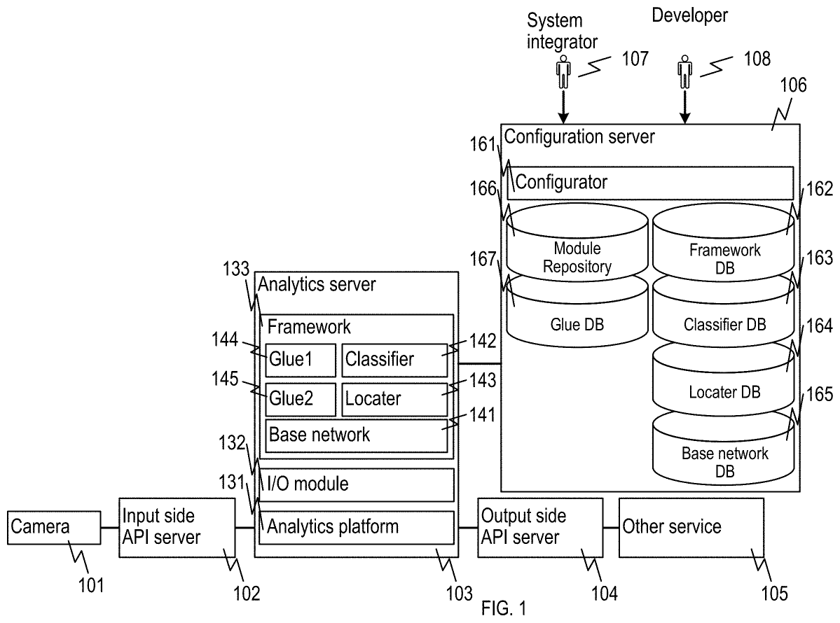

FIG. 1 illustrates a system diagram of an example Q&A based object detection system and auto build system in accordance with an example implementation. The example system includes at least one camera 101, one input side application programming interface (API) server 102, one analytics server 103, one output side API server 104, one other micro service 105 and configuration server 106.

The analytics server 103 involves an analytics platform 131, an Input/Output (I/O) module 132 and a framework 133. Both the I/O module 132 and framework 133 are scripts and/or executables running on and/or around the analytics platform 131. The framework 133 is an object detection framework and is configured to conduct object detection. The I/O module 132 delivers data bidirectionally between the analytics module 131 and the framework 133. The framework 133 involves a base network 141, and can further involve a classifier 142 and a locator 143 with glues 144, 145.

The configuration server 106 involves a configurator 161, a framework database (DB) 162, a classifier DB 163, a locator DB 164, a base network DB 165, a module repository 166 and a glue DB 167.

At least one developer 108 develops scripts and/or executables for the I/O module 132 and the framework 133 including the base network 141, the classifier 142, the locator 143 and glues 144 and 145. The scripts and/or executables are stored into the module repository 166, and the meta data is stored into the framework DB 162, the classifier DB 163, the locator DB 164, the base network DB 165, the module repository 166 and the glue DB 167.

At least one system integrator 107 operates the Q&A based object detection system and auto build system through the configuration server 106.

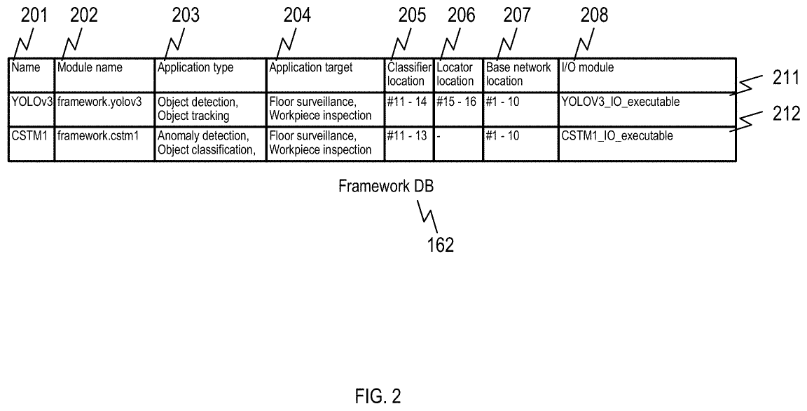

FIG. 2 illustrates an example of the framework DB 162 table in accordance with an example implementation. For example, the framework DB 162 includes a name column 201, a module name column 202, an application type column 203, an application target column 204, a classifier location column 205, a locator location column 206, a base network location column 207 and an I/O module column 208.

The name column 201 stores the name of the framework. The module name column 202 stores the name of the module of the framework. Modules can be a script and/or an executable running on and/or around the analytics platform 131. The application type column 203 stores the name of the applicable application type(s) such as object detection and object tracking. Further, the application target column 204 stores the name of the applicable application target(s) such as floor surveillance and workpiece inspection.

The classifier location column 205, the locator location column 206 and base network location column 207 stores the associated location of the classifier in the framework if such location is applicable. In this example, the framework is implemented by using neural network therefore the location is described by using begin/end numbers of layers.

The I/O module column 208 stores a name of the I/O module for the framework. I/O Modules can be a script and/or an executable running on and/or around the analytics platform 131.

Rows 211 and 212 are example entries of the framework DB 162 table.

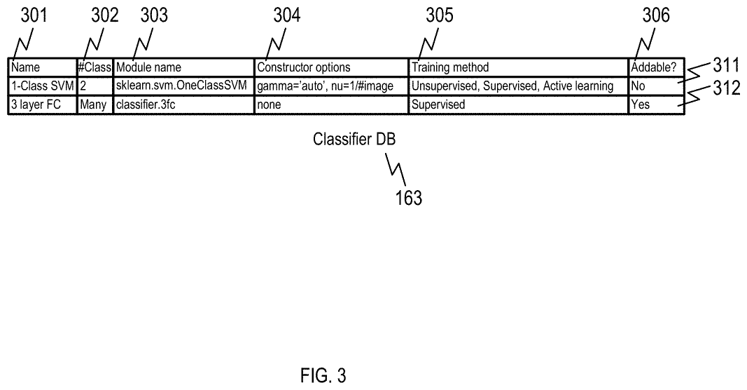

FIG. 3 illustrates an example of the classifier DB 163 table in accordance with an example implementation. For example, the classifier DB 163 table includes a name column 301, a #class column 302, a module name column 303, a constructor options column 304, a training method column 305 and an addable column 306.

The name column 301 stores the name(s) of the classifier network. The #class column 302 stores a number indicative of how many classes to which the classifier can be classified. In an example, the entry “Many” is a reserved word to show the classifier can classify any number. The module name column 303 stores the name of the module of the classifier. Modules can be a script and/or an executable running on and/or around the analytics platform 131. The constructor options column 304 stores options that are given when the module is constructed. The training method column 305 stores the name(s) of the applicable training method such as unsupervised, supervised and active learning. The addable column 306 stores the method(s) regarding how the configurator combines the base network and the classifier. In this example, assuming the analytics platform 103 is Keras, most of the frameworks, classifiers, locators and base networks are implemented by using the Sequential model API and add( ) method can be utilize for combining such frameworks, classifiers, locators and base networks, and thus the value of the addable column 306 is yes. Whereas if the frameworks, classifiers, locators and base networks do not use the Sequential API, then the Functional API can be used instead, and thus the value of the addable column is no.

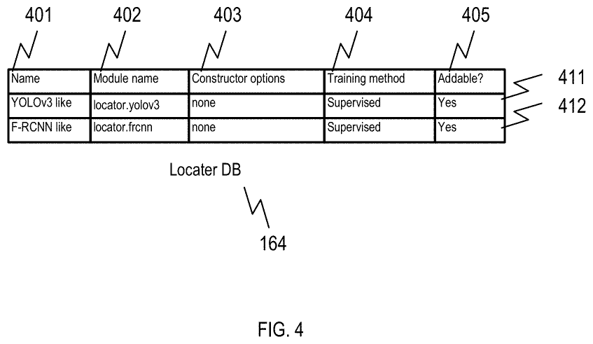

FIG. 4 illustrates an example of the locator DB 164 table in accordance with an example implementation. The columns are similar to those as the classifier DB of FIG. 3. For example, locator DB 164 can include name column 401, module name column 402, constructor option column 403, training method column 404, and addable column 405, which correspond to the same columns as the classifier DB of FIG. 3 with example entries 411 and 412.

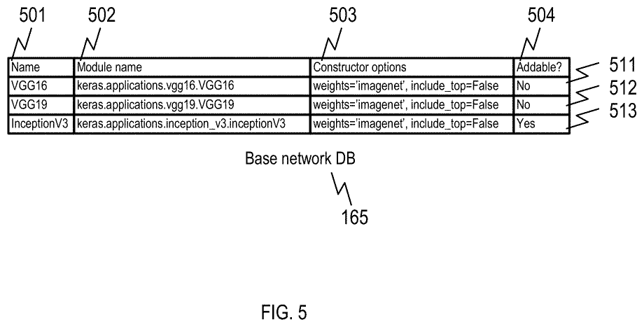

FIG. 5 illustrates an example of the base network DB 165 table in accordance with an example implementation. The columns are similar to those as the classifier DB of FIG. 3. For example, base network DB 164 can include name column 501, module name column 502, constructor option column 503, and addable column 504, which correspond to the same columns as the classifier DB of FIG. 3. with example entries 511, 512, and 513.

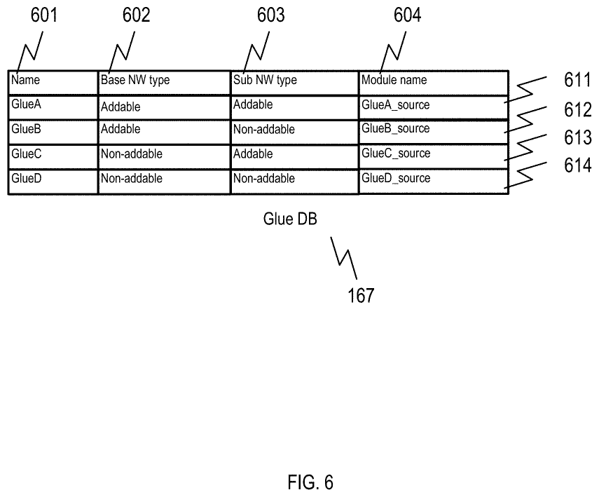

FIG. 6 illustrates an example of the glue DB 167 table in accordance with an example implementation. For example, the glue DB 167 table includes a name column 601, a base network (NW) column 602, a sub NW column 603, and a module name column 604.

The name column 601 stores the name of the glue. The base NW type column 602 stores the condition indicative of whether the base NW that the glue is adapted to is addable or not. The sub NW type column 603 stores the condition indicative of whether the sub NW that the glue is adapted to is addable or not. In this example, the sub NW includes the classifier 142 and the locator 143. The module name column 604 stores the name of the module of the glue. Modules can be a script and/or an executable running on and/or around the analytics platform 131.

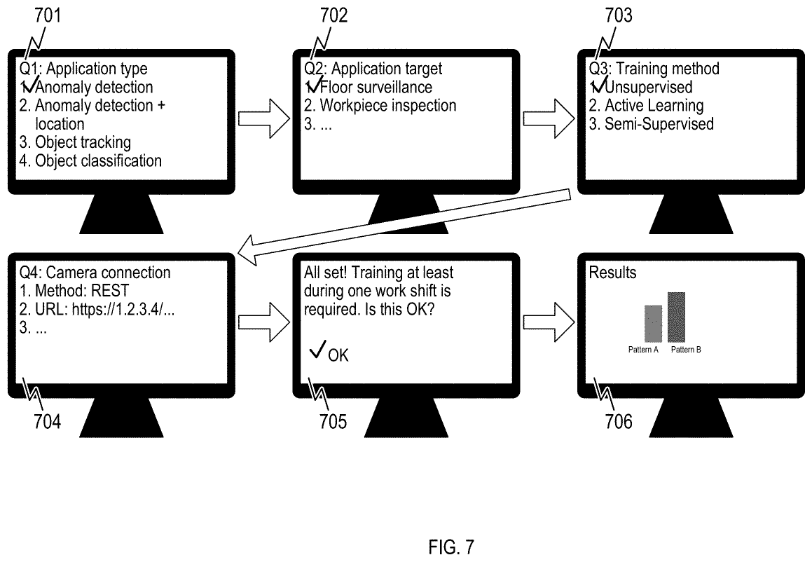

FIG. 7 illustrates an example of flow and interfaces of the Q&A system in accordance with an example implementation. In an example implementation, the Q&A system asks some questions to the system integrator 107 to narrow down the candidates. Such an implementation can facilitate practical video analytics because the computing cost can be expensive, and trying all methods and combination of methods through brute force may not be feasible. In an example implementation, at 701, the Q&A system asks about the type of the application to the system integrator 107 by showing options. At 702, the Q&A system asks about the target of the application to the system integrator 107 by showing options. At 703, the Q&A system asks about the training method to the system integrator 107 by showing options. At 704, the Q&A system asks about the camera 101 to the system integrator 107. At 705, the Q&A system asks a confirmation to the system integrator 107. Then the Q&A system builds the object detection modules, trains the modules as required, and calculates well-known KPIs such as precision and specificity for all modules. At 706, the Q&A systems show comparisons of all modules by showing well-known KPIs.

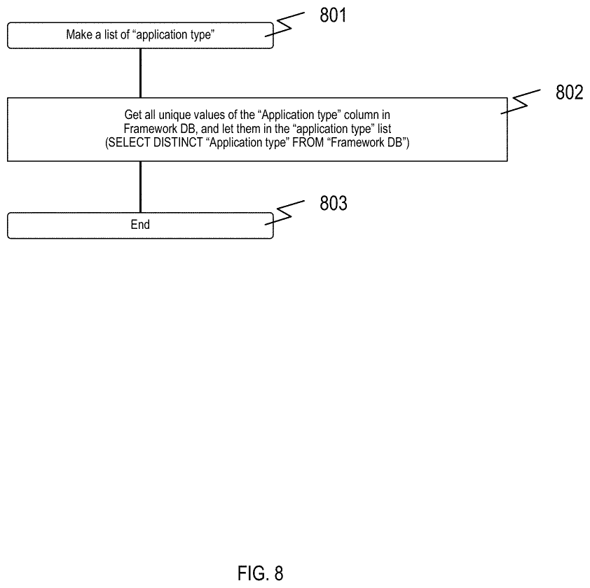

FIG. 8 illustrates a flow chart of an example configurator 161 process in accordance with an example implementation. Before showing the screen 701, the configurator 161 process execute this procedure to make a list of application types. At 801, the configurator 161 starts to execute this procedure for making a list of the application type. At 802, the configurator 161 process obtains all unique values of the “Application type” column in Framework DB 163 and stores them in the “application type” list. The following Sequential Query Language (SQL) statement obtains all unique values of the “Application type” column in Framework DB 163.

SELECT DISTINCT “Application type” FROM “Framework DB”

At 803, the configurator 161 finishes the flow.

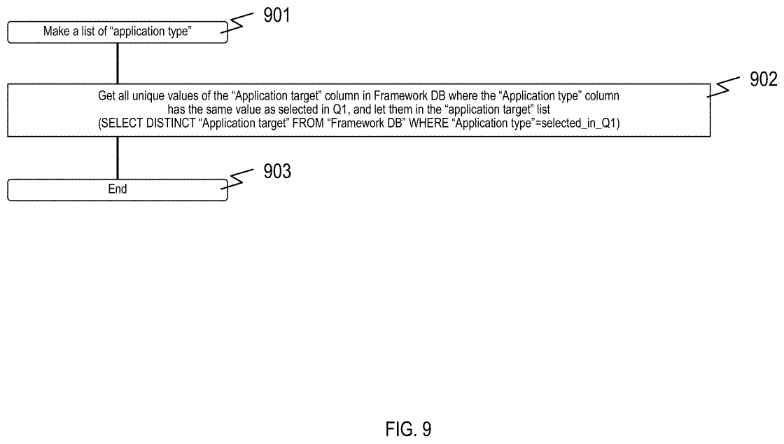

FIG. 9 illustrates a flow chart of an example configurator 161 process in accordance with an example implementation. Before showing the screen 702, the configurator 161 process executes this procedure to make a list of application targets. At 901, the configurator 161 starts to execute the procedure for making a list of the application type. At 902, the configurator 161 process obtains all unique values of the “Application target” column in Framework DB 163 in which the “Application type” column has the same value as selected in Q1 and stores them in the “application target” list. The following SQL statement obtains all unique values of the “Application target” column in Framework DB 163 in which the “Application type” column has the same value as selected in Q1.

SELECT DISTINCT “Application target” FROM “Framework DB”

WHERE “Application type”=selected_in_Q1

At 903, the configurator 161 process finishes the flow.

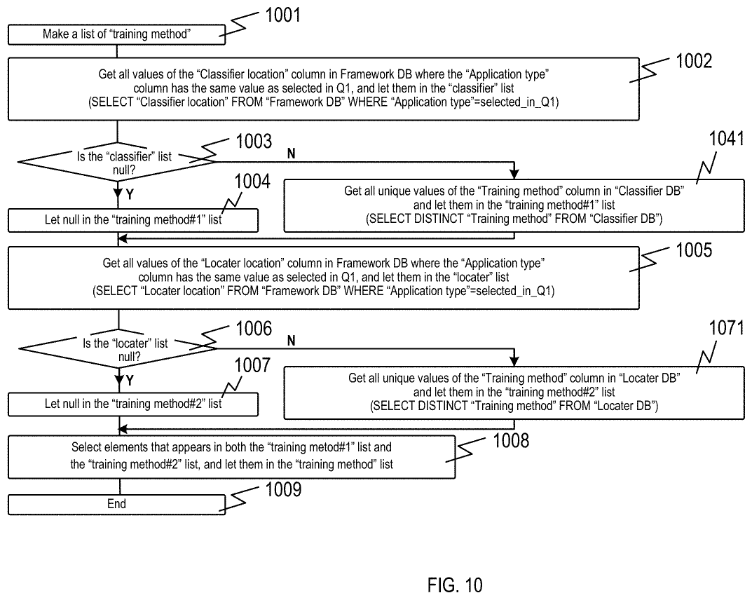

FIG. 10 illustrates a flow chart of an example configurator 161 process in accordance with an example implementation. Before showing the screen 703, the configurator 161 process execute this procedure to make a list of the training methods at 1001.

At 1002, the configurator 161 process gets all values of the “Classifier location” column in Framework DB 162 where the “Application type” column has the same value as selected in Q1 and let them in the “classifier” list. The following SQL statement gets all values of the “Classifier location” column in Framework DB 162 where the “Application type” column has the same value as selected in Q1.

SELECT “Classifier location” FROM “Framework DB” WHERE

“Application type”=selected_in_Q1

At 1003, the configurator 161 process detects whether or not the classifier list is null. If the classifier list is null (Y), then at 1004, the configurator 161 process provides null in the training method #1 list. Otherwise (N), then at 1041, the configurator 161 process obtains all unique values of the “Training method” column in “Classifier DB” 163 and let them in the “training method #1” list. The following SQL statement gets all unique values of the “Training method” column in “Classifier DB” 163.

SELECT DISTINCT “Training method” FROM “Classifier DB”

At 1005, the configurator 161 process gets all values of the “Locator location” column in Framework DB 162 in which the “Application type” column has the same value as selected in Q1 and places them in the “locator” list. The following SQL statement gets all values of the “Locator location” column in Framework DB 162 in which the “Application type” column has the same value as selected in Q1.

SELECT “Locater location” FROM “Framework DB” WHERE

“Application type”=selected_in_Q1

At 1006, the configurator 161 process detects whether or not the locator list is null. If the classifier list is null (Y), then at 1007, the configurator 161 process provides null in the training method #2 list. Otherwise (N), then at 1071, the configurator 161 process obtains all of the unique values of the “Training method” column in “Locator DB” 164 and places them in the “training method #2” list. The following SQL statement gets all unique values of the “Training method” column in “Locator DB” 164.

SELECT DISTINCT “Training method” FROM “Locator DB”

At 1008, the configurator 161 process selects elements that appears in both the “training method #1” list and the “training method #2” list and places them in the “training method” list.

At 1009, the configurator 161 process finishes the flow.

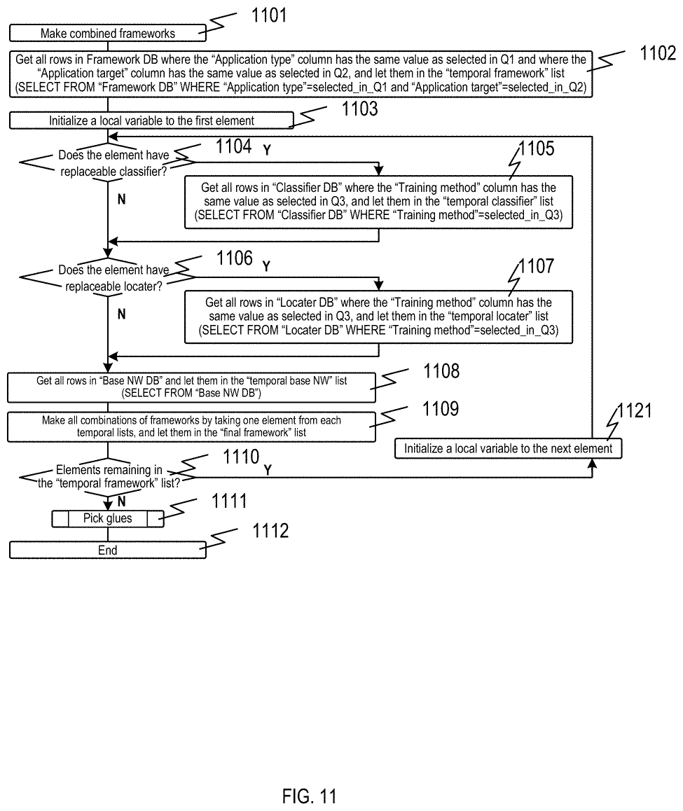

FIG. 11 illustrates a flow chart of an example configurator 161 process in accordance with an example implementation. After confirmation 705, the configurator 161 process execute this procedure to make combined frameworks. At 1101, the configurator 161 process starts to execute this procedure to make combined frameworks.

At 1102, the configurator 161 process gets all rows in Framework DB 162 where the “Application type” column has the same value as selected in Q1 and where the “Application target” column has the same value as selected in Q2, and let them in the “temporal framework” list. The following SQL statement gets all rows in Framework DB 162 where the “Application type” column has the same value as selected in Q1 and where the “Application target” column has the same value as selected in Q2.

SELECT * FROM “Framework DB” WHERE “Application

type”=selected_in_Q1 and “Application target”=selected_in_Q2

At 1103, the configurator 161 process initialize a local variable to the first element of the temporal framework list for looping. At 1104, the configurator 161 process detects whether or not the element has a replaceable classifier. In this example, if the row of the framework DB 162 has values in the classifier location column 205, the element having the same name 201 value has a replaceable classifier. If the element has a replaceable classifier (Y), then at 1105, the configurator 161 process gets all rows in “Classifier DB” 163 where the “Training method” column has the same value as selected in Q3, and let them in the “temporal classifier” list. The following SQL statement gets all rows in “Classifier DB” 163 where the “Training method” column has the same value as selected in Q3.

SELECT * FROM “Classifier DB” WHERE “Training method”=selected_in_Q3

At 1106, the configurator 161 process detects whether or not the element has a replaceable locator. In this example, if the row of the framework DB 162 has values in the locator location column 206, the element having the same name 201 value has replaceable locator. If the element has replaceable locator (Y), then at 1107, the configurator 161 gets all rows in “Locator DB” 164 where the “Training method” column has the same value as selected in Q3, and places them in the “temporal locator” list. The following SQL statement gets all rows in “Locator DB” 164 where the “Training method” column has the same value as selected in Q3.

SELECT * FROM “Locator DB” WHERE “Training method”=selected_in_Q3

At 1108, the configurator 161 process gets all rows in “Base NW DB” 165, and places them in the “temporal base NW” list. The following SQL statement gets all rows in “Base NW DB” 165.

SELECT * FROM “Base NW DB”

At 1109, the configurator 161 process makes all combinations of frameworks by taking one element from each of the temporal lists, and places them in the “final framework” list.

At 1110, the configurator 161 process detects whether or not there are elements remaining in the “temporal framework” list. If there are elements remaining (Y), at 1121, the configurator 161 initializes a local variable to the next element and then proceeds to 1104. Otherwise (N) the flow proceeds to 1111, wherein the configurator 161 picks glues 1111 from the glue DB 167. At 1112, the configurator 161 process finishes the flow.

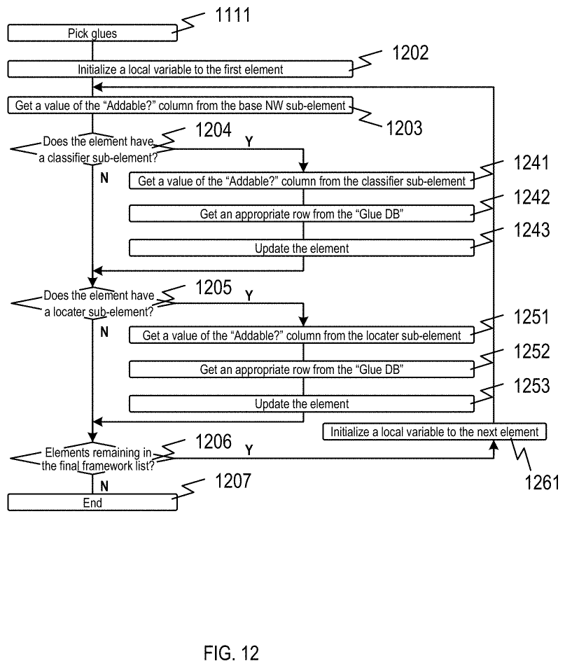

FIG. 12 illustrates a flow chart of an example configurator 161 process in accordance with an example implementation. Specifically, FIG. 12 provides a detailed flow of step 1111 of FIG. 11. At 1202, the configurator 161 process initializes a local variable to the first element of the final framework list for the loop. At 1203, the configurator 161 process obtains the value of the “Addable?” column from the base NW sub-element in the “final framework” list. At 1204, the configurator 161 process decides whether or not the element has a classifier sub-element. If the element has the classifier sub-element (Y), then at 1241, the configurator 161 process obtains a value of the “Addable?” column from the classifier sub-element. At 1242, the configurator 161 process obtains the appropriate row from the “Glue DB” based on conditions of the base NW's “addable?” column obtained from 1203 and the classifier's “addable?” column got in the step 1241. Then at 1243, the configurator 161 process update the element by the glue got in the step 1242.

The same process is repeated for the locator in the process of 1205, 1251, 1252 and 1253.

At 1206, the configurator 161 process detects whether or not elements remain in the final framework list. If elements still remain (Y), at 1261, the configurator 161 initializes a local variable to the next element and go to 1203. Otherwise (N) the flow proceeds to 1207, the configurator 161 process finishes the flow.

Through the flows as described herein, the example implementations thereby build and construct an object detection system.

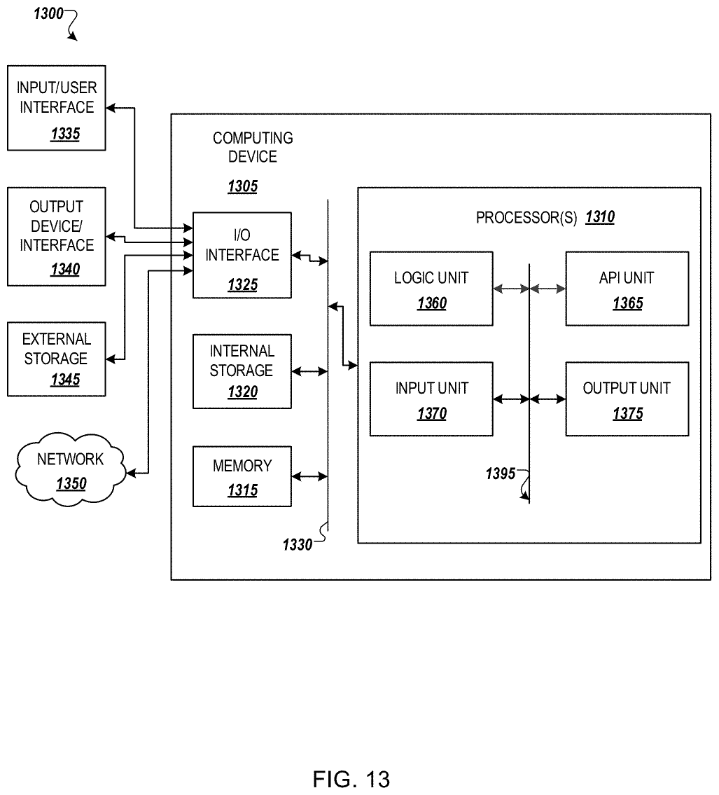

FIG. 13 illustrates an example computing environment with an example computer device suitable for use in example implementations. Computer device 1305 in computing environment 1300 can include one or more processing units, cores, or processors 1310, memory 1315 (e.g., RAM, ROM, and/or the like), internal storage 1320 (e.g., magnetic, optical, solid state storage, and/or organic), and/or I/O interface 1325, any of which can be coupled on a communication mechanism or bus 1330 for communicating information or embedded in the computer device 1305.

Computer device 1305 can be communicatively coupled to input/user interface 1335 and output device/interface 1340. Either one or both of input/user interface 1335 and output device/interface 1340 can be a wired or wireless interface and can be detachable. Input/user interface 1335 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1340 may include a display, television, monitor, printer, speaker, braille, or the like. In some example implementations, input/user interface 1335 and output device/interface 1340 can be embedded with or physically coupled to the computer device 1305. In other example implementations, other computer devices may function as or provide the functions of input/user interface 1335 and output device/interface 1340 for a computer device 1305. In example implementations involving a touch screen display, a television display, or any other form of display, the display is configured to provide a user interface.

Examples of computer device 1305 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1305 can be communicatively coupled (e.g., via I/O interface 1325) to external storage 1345 and network 1350 for communicating with any number of networked components, devices, and systems, including one or more computer devices of the same or different configuration. Computer device 1305 or any connected computer device can be functioning as, providing services of, or referred to as a server, client, thin server, general machine, special-purpose machine, or another label.

I/O interface 1325 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1300. Network 1350 can be any network or combination of networks (e.g., the Internet, local area network, wide area network, a telephonic network, a cellular network, satellite network, and the like).

Computer device 1305 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1305 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1310 can execute under any operating system (OS) (not shown), in a native or virtual environment. One or more applications can be deployed that include logic unit 1360, application programming interface (API) unit 1365, input unit 1370, output unit 1375, and inter-unit communication mechanism 1395 for the different units to communicate with each other, with the OS, and with other applications (not shown). The described units and elements can be varied in design, function, configuration, or implementation and are not limited to the descriptions provided. Processor(s) 1310 can be in the form of physical processors or central processing units (CPU) that is configured to execute instructions loaded from Memory 1315.

In some example implementations, when information or an execution instruction is received by API unit 1365, it may be communicated to one or more other units (e.g., logic unit 1360, input unit 1370, output unit 1375). In some instances, logic unit 1360 may be configured to control the information flow among the units and direct the services provided by API unit 1365, input unit 1370, output unit 1375, in some example implementations described above. For example, the flow of one or more processes or implementations may be controlled by logic unit 1360 alone or in conjunction with API unit 1365. The input unit 1370 may be configured to obtain input for the calculations described in the example implementations, and the output unit 1375 may be configured to provide output based on the calculations described in example implementations.

In an example implementation, computer device 1305 can be in the form of a first server such as a configuration server 106 that configures a second server such as analytics server 103 to conduct image analytics. In such an example implementation, memory 1315 can manage one or more databases, such as module repository 166, glue DB 167, framework DB 162, classifier DB 163, locator DB 164 and Base network DB 165 as illustrated from FIGS. 1-6. Processor(s) 1310 can be configured to receive an application type, a target of an application, a training method for the application, and a camera through selections on the interfaces of FIG. 7; determine one or more frameworks that are associated with both the application type and the target of the application, determine one or more locators and one or more classifiers associated with the application type for the one or more frameworks based on the application type, construct a base network for the one or more frameworks, extract glue modules linking the one or more classifiers and the one or more locators to the base network for the one or more frameworks; and configure the second server with the one or more frameworks to execute analytics on images received from the camera through the execution of the flow of FIG. 11.

In an example implementation, processor(s) 1310 can be configured to extract glue modules linking the one or more classifiers and the one or more locators to the base network for the one or more frameworks by for each element of the one or more frameworks, for the each element having a classifier sub-element, obtain the glue modules corresponding to the classifier sub-element; and for the each element having a locator sub-element, obtaining the glue modules corresponding to the locator sub-element as illustrated in FIG. 12.

In an example implementation, the application type can be one or more of anomaly detection, anomaly location, object tracking, and object classification as illustrated in FIG. 7.

In an example implementation, processor(s) 1310 can be configured to determine the one or more frameworks that are associated with both the application type and the target of the application by referring to a database associating a plurality of frameworks with a plurality of application types and a plurality of application targets as illustrated in FIGS. 2 and 8.

In an example implementation, processor(s) 1310 can be further configured to determine a list of training methods that can be utilized based on the one or more locators and the one or more classifiers associated with the application, and wherein the training method is received from a selection among the list of training methods as illustrated in FIG. 10.

In an example implementation, processor(s) 1310 can be configured to extract the glue modules linking the one or more classifiers and the one or more locators to the base network for the one or more frameworks comprises referring to a database associating a plurality of glue modules to a plurality of base networks and a plurality of sub networks as illustrated in FIG. 6.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for a first server to configure a second server to conduct image analytics, the method comprising:
receiving an application type, a target of an application, a training method for the application, and a camera;
determining one or more frameworks that are associated with both the application type and the target of the application;
determining one or more locators and one or more classifiers associated with the application type for the one or more frameworks based on the application type;
constructing a base network for the one or more frameworks;
extracting glue modules linking the one or more classifiers and the one or more locators to the base network for the one or more frameworks; and
configuring the second server with the one or more frameworks to execute analytics on images received from the camera.

2. The method of claim 1, wherein the extracting glue modules linking the one or more classifiers and the one or more locators to the base network for the one or more frameworks comprises:
for each element of the one or more frameworks:
for the each element having a classifier sub-element, obtain the glue modules corresponding to the classifier sub-element; and
for the each element having a locator sub-element, obtaining the glue modules corresponding to the locator sub-element.

3. The method of claim 1, wherein the application type is one or more of anomaly detection, anomaly location, object tracking, and object classification.

4. The method of claim 1, wherein the determining the one or more frameworks that are associated with both the application type and the target of the application comprises referring to a database associating a plurality of frameworks with a plurality of application types and a plurality of application targets.

5. The method of claim 1, further comprising determining a list of training methods that can be utilized based on the one or more locators and the one or more classifiers associated with the application, and wherein the training method is received from a selection among the list of training methods.

6. The method of claim 1, wherein the extracting the glue modules linking the one or more classifiers and the one or more locators to the base network for the one or more frameworks comprises referring to a database associating a plurality of glue modules to a plurality of base networks and a plurality of sub networks.

7. A non-transitory computer readable medium, storing instructions for a first server to configure a second server to conduct image analytics, the instructions comprising:
receiving an application type, a target of an application, a training method for the application, and a camera;
determining one or more frameworks that are associated with both the application type and the target of the application;
determining one or more locators and one or more classifiers associated with the application type for the one or more frameworks based on the application type;
constructing a base network for the one or more frameworks;
extracting glue modules linking the one or more classifiers and the one or more locators to the base network for the one or more frameworks; and
configuring the second server with the one or more frameworks to execute analytics on images received from the camera.

8. The non-transitory computer readable medium of claim 7, wherein the extracting glue modules linking the one or more classifiers and the one or more locators to the base network for the one or more frameworks comprises:
for each element of the one or more frameworks:
for the each element having a classifier sub-element, obtain the glue modules corresponding to the classifier sub-element; and
for the each element having a locator sub-element, obtaining the glue modules corresponding to the locator sub-element.

9. The non-transitory computer readable medium of claim 7, wherein the application type is one or more of anomaly detection, anomaly location, object tracking, and object classification.

10. The non-transitory computer readable medium of claim 7, wherein the determining the one or more frameworks that are associated with both the application type and the target of the application comprises referring to a database associating a plurality of frameworks with a plurality of application types and a plurality of application targets.

11. The non-transitory computer readable medium of claim 7, the instructions further comprising determining a list of training methods that can be utilized based on the one or more locators and the one or more classifiers associated with the application, and wherein the training method is received from a selection among the list of training methods.

12. The non-transitory computer readable medium of claim 7, wherein the extracting the glue modules linking the one or more classifiers and the one or more locators to the base network for the one or more frameworks comprises referring to a database associating a plurality of glue modules to a plurality of base networks and a plurality of sub networks.

13. A first server to configure a second server to conduct image analytics, the server comprising:
a processor, configured to:
receive an application type, a target of an application, a training method for the application, and a camera;
determine one or more frameworks that are associated with both the application type and the target of the application;
determine one or more locators and one or more classifiers associated with the application type for the one or more frameworks based on the application type;
construct a base network for the one or more frameworks;
extract glue modules linking the one or more classifiers and the one or more locators to the base network for the one or more frameworks; and
configure the second server with the one or more frameworks to execute analytics on images received from the camera.

14. The first server of claim 13, wherein the processor is configured to extract glue modules linking the one or more classifiers and the one or more locators to the base network for the one or more frameworks by:
for each element of the one or more frameworks:
for the each element having a classifier sub-element, obtain the glue modules corresponding to the classifier sub-element; and
for the each element having a locator sub-element, obtaining the glue modules corresponding to the locator sub-element.

15. The first server of claim 13, wherein the application type is one or more of anomaly detection, anomaly location, object tracking, and object classification.

16. The first server of claim 13, wherein the processor is configured to determine the one or more frameworks that are associated with both the application type and the target of the application by referring to a database associating a plurality of frameworks with a plurality of application types and a plurality of application targets.

17. The first server of claim 13, the processor further configured to determine a list of training methods that can be utilized based on the one or more locators and the one or more classifiers associated with the application, and wherein the training method is received from a selection among the list of training methods.

18. The first server of claim 13, wherein the processor is configured to extract the glue modules linking the one or more classifiers and the one or more locators to the base network for the one or more frameworks by referring to a database associating a plurality of glue modules to a plurality of base networks and a plurality of sub networks.
